(19) United States
(12) Patent Application Publication
(10) Pub. No.: US 2018/0283412 A1
(43) Pub. Date: Oct. 4, 2018

(54) VALVE ISLAND

(71) Applicant: BUERKERT WERKE GMBH & CO. KG., Ingelfingen (DE)

(72) Inventors: Martin HETTINGER, Ingelfingen (DE); Volker RUFF, Rot am See (DE)

(21) Appl. No.: 15/933,677

(22) Filed: Mar. 23, 2018

(30) Foreign Application Priority Data
Mar. 31, 2017 (DE) 102017106892.9

(51) Int. Cl. F15B 13/08

(52) U.S. Cl. CPC F15B 13/0825; F15B 13/0832; F15B 13/0857; F15B 13/0875; F15B 13/0867

(57) ABSTRACT

A valve island has at least one valve module (12) and on a first outer surface (20) a fastening structure (18) extending in a line-up direction (A), in particular for fastening to a mounting rail (24). On at least one second surface (30), which extends substantially perpendicularly to the line-up direction (A), a first and a second electrical contact area (26, 28) are provided, wherein the fastening structure (18) lies between the two electrical contact areas (26, 28).

### FIELD OF THE INVENTION

This invention relates to a valve island with at least one valve module.

### BACKGROUND

Valve islands are units comprising numerous valves which are separate components with an own outer housing. The valves are attachable next to each other along a line-up direction to a separate fastening structure, i.e. a separate component. The valves and the common fastening structure define the valve island. The valves can be attached to and removed from the fastening structure. Thus, valve islands are flexibly usable modules wherein the number of valves attached to the fastening structure can be easily adapted to the use and purpose of the valve island. Valve islands are assemblies that are used for example for actuating complex pneumatic systems. A plurality of valves thereby can be constructionally combined in one place and can be supplied with electric and fluidic energy (by a pneumatic or hydraulic control fluid) e.g. via a common central supply unit.

Often, a variety of modules, also application-specific modules designed for example as valve modules, purely electronic modules, diagnosis modules or fluid feed modules, are plugged together along a line-up direction according to a modular system. In general, such valve islands thereby offer a very high flexibility.

It is known to couple the individual modules of the valve island to each other along the line-up direction, for example due to the fact that all modules each are provided with a fastening structure on their back, with which they can be pushed onto a common mounting rail, such as a top-hat rail.

In such valve islands the electric supply for example is effected by continuous supply lines that extend over the entire valve island along the line-up direction and thus centrally supply all modules with electric energy. Each individual module can include a portion of the electric supply line, wherein the portions are joined by plugging the individual modules together via electrical interfaces (plugs and sockets) to obtain a continuous electric voltage supply.

Just as well, a continuous data bus, consisting of one or more data lines, often is provided, which all modules of the valve island can access and via which all modules and valves of the valve island can be addressed.

It is the object of the invention to simplify the coupling of modules to a valve island.

### SUMMARY

The invention provides a valve island with at least one valve module which has a fastening structure extending in a line-up direction on a first outer surface, in particular for fastening to a mounting rail, and on at least one second surface that extends substantially perpendicularly to the line-up direction a first and a second electrical contact area, wherein the fastening structure lies between the two electrical contact areas. The second surface normally forms an outer surface of the respective outermost module of the valve island, to which a further suitable module can be joined in a line-up direction. In this way, the transverse forces are reduced, which act on the electrical contact when attaching and coupling a module to other modules of the valve island, whereby the risk of canting of the electrical contacts to be plugged into each other is reduced. According to the invention the resulting forces are distributed on both sides of the fastening structure, which specifies the plug-in direction, so that unilateral loads are avoided.

Of course, further contact areas can also be provided. The same then preferably likewise are distributed on the second surface as uniformly as possible with respect to the fastening structure in order to achieve a rather uniform mechanical load on closing the contacts.

The fastening structure preferably is a groove that extends over the entire first outer surface of the valve island, wherein the first outer surface advantageously forms a rear side of the valve island. The second surface in particular is a front side of the valve island pointing in a line-up direction.

Preferably, the valve island includes a plurality of adjacent modules configured as separated assemblies, among them the at least one valve module, wherein the modules can be coupled to each other and can again be constructionally separated from each other, so that the actual valve island can be flexibly assembled of the modules just required according to a modular principle. The entire electrical contacting of the modules can be effected within the valve island via electrical contact areas on the respective front sides of the modules.

For securely interconnecting individual modules at least one latching element of a latching device can be provided on the second surface, which in particular is usable for fastening a further module expanding the valve island.

The latching element preferably is arranged in the region of the fastening structure, so that the latching connection is closed when it is pushed in a line-up direction in particular onto the mounting rail on which the remaining modules of the valve island are arranged already, without the significant occurrence of transverse forces. As seen perpendicularly to the line-up direction, the latching element preferably lies between the two contact areas. The latching element for example is formed by a latching hook or another suitable latching structure.

To be able to again release the latching connection and separate the further module plugged in from the remaining valve island, the latching device for example comprises an actuating device, in particular on the underside of the valve island, via which the latching element can be moved.

The first electrical contact area advantageously serves a voltage supply of the valve island, and the second electrical contact area serves a data transmission. In this way, the lines for energy supply can be guided spatially separate from the lines for data communication, which attenuates the mutual influence of the contact areas and reduces electromagnetic interferences. The assembly according to the invention thus also improves the electromagnetic compatibility of the valve island.

Of course, each of the electrical contact areas can include several separate contacts and for example be configured as a multipole plug or socket. In general, each line connected to an electrical contact area can include only one single line strand or a plurality of line strands. This can be e.g. a ribbon cable, but also a printed circuit board with conductor paths.

To simplify plugging together, one of the two electrical contact areas for example can be formed as a plug and the other one as a socket.

Of course, on the module to be plugged in a counter-contact area each is formed in principle, which includes the respective complementary element, so that plug meets socket or socket meets plug.

The plugs and sockets of the electrical contact areas on the two front sides both of the adapter module and preferably of the other modules of the valve island normally are of complementary design, so that a contact area and a counter-contact area each meet.

Preferably at least one of the electrical contact areas is raised with respect to the surrounding second surface. When plugging the same together, a guidance and centering of the module to be plugged in automatically is obtained.

In a preferred embodiment, the valve island comprises an adapter module on which the first and the second electrical contact area is provided, wherein a first front side of the adapter module forms at least one portion of the second surface of the valve island.

As already mentioned above, the valve island in principle can consist of a sequence of individual modules, wherein for example valve modules, feed modules for fluids or also purely electronic modules can be provided.

Valve modules normally comprise at least one valve controllable via the control fluid, which in particular can operate an externally connected actuator such as an external pneumatic valve or a pneumatic cylinder.

Via the feed modules any fluids can be fed into the valve islands or be discharged from the same. Via such modules a central supply for example with process or rinsing fluids can also be effected.

Purely electronic modules can be designed for example for the control of electric drives or as diagnosis modules.

The individual modules generally are constructionally separate units.

It is also possible, however, to combine several functional units, in particular valve units, on a base body provided for example with fluid interfaces and a central energy supply, wherein this assembly then is mounted in the valve island as one of the modules, in this case as a valve module. In such a base body, for example, at least a part of the fluid supply and/or the electric lines for voltage supply and data transmission can be provided. Individual modules then can be plugged in on the base body.

The dimension of the front side of the adapter module preferably at least approximately corresponds to that of the subsequent component of the valve island, for example to a feed module or to a valve module, possibly including a base body. The fastening structure preferably is also provided on the adapter module itself, but might also be formed on the base body only, in case the adapter module also is plugged in on the base body.

When the adapter module laterally terminates the valve island, the latching device advantageously is arranged on the adapter module in order to provide for fastening a further module, which in particular is a purely electric or electronic module, to the adapter module.

Into the adapter module a feed module can be integrated, which is part of a fluid supply of the valve island and which provides for a supply and/or discharge of one or more fluids to the fluid-carrying parts of the valve island. The feed module can perform the entire fluid supply of the valve island. It is also possible, however to integrate for example further feed modules into the valve island, via which fluids likewise can be supplied and/or discharged.

The first front side of the adapter module, however, preferably is configured free from fluid ports, so that fluid ports only are provided on the second front side of the adapter module facing the at least one valve module in the valve island. The first front side on the other hand preferably only includes electrical connections in the at least two electrical contact areas, but no fluidic interface or other fluid ports. Normally, the further module that is plugged to the adapter module is a purely electric or electronic module without any fluid lines. Therefore, a fluid supply is not necessary for these modules, and the fluid lines are not guided up to the first front side of the adapter module.

The electrical contact areas can be arranged differently on the first front side and on the second front side of the adapter module, in particular in order to account for the arrangement of the fluid ports or fluidic interfaces on the second front side.

Alternatively, the feed module can of course also be configured as a separate module, but the integration into the adapter module also can be advantageous because the adapter module then can perform a certain diagnosis with respect to the fluid supply and discharge.

In the adapter module a circuit unit preferably is provided, which is connected to the first and the second electrical contact area. The circuit unit forms an internal electronic unit of the adapter module and can comprise the entire internal electronic unit of the adapter module. In this circuit unit for example at least one additional internal data bus of the valve module and/or at least one additional internal voltage supply of the valve module for example with a voltage different from the supply voltage can also be provided. For this purpose for example the second front side can include a further electrical contact area in which interfaces of the internal voltage supply of the valve module and internal data lines of the valve module are combined to an internal bus.

Possibly, the circuit unit of the adapter module can also include an electromagnetic protection device in the form of an EMC wiring that acts on the voltage supply and/or the data lines and can offer protection from overvoltage or undervoltage or other disturbances. Possibly, the circuit unit also can provide for a controlled switching-off of individual valve modules of the valve island.

The two opposite end-face front sides of the valve island pointing in line-up direction, which delimit the valve island, can be formed by adapter modules, so that on both sides of the adapter modules the option is to connect a further module, in particular a purely electric or electronic module, to the valve island.

The further modules preferably have at least one electrical counter-contact area and a fastening structure, wherein the at least one electrical counter-contact area makes a plug connection with the first and/or the second electrical contact area, and the fastening structure in particular can be plugged in on the same mounting rail as the remaining modules of the valve island.

Preferably, the plug connections of the electrical contacting in the electrical contact areas can be closed and released again purely by shifting along the line-up direction.

To securely connect the further module to the adapter module, the further module preferably includes a counter latching element that makes a latching connection with an adjacent latching element, in particular on the adapter module.

### BRIEF DESCRIPTION OF THE DRAWINGS

FIG. 1 shows a schematic view of a valve island according to the invention, plugged in on a mounting rail;

FIG. 2 shows a schematic top view of the front side of the valve island of FIG. 1; and

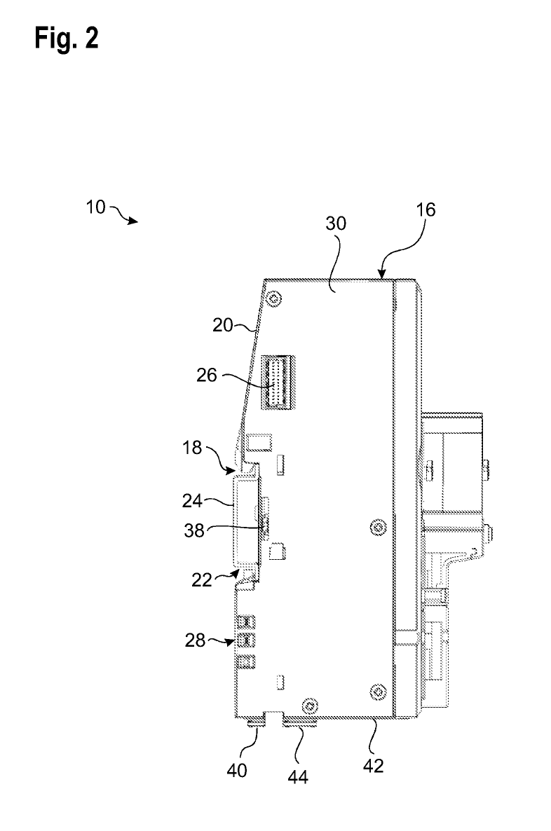

FIG. 3 shows a schematic perspective representation of the valve island of FIG. 1 with an attached further module.

### DETAILED DESCRIPTION

The Figures show an electrofluidic valve island 10. Such valve island 10 comprises a plurality of modules, among them one or more valve modules 12.

In this example, the valve modules 12 are constructed such that a (non-illustrated) base body each carries a plurality of valve units 12a that are plugged in on the base body. In addition, there is each provided an electronic unit 12b via which the individual valve units 12a can be actuated.

The valve units 12a shown here each comprise a main valve and a pilot valve that fluidically controls the main valve. Via their main valves, the valve units 12a for example control externally connected actuators (not shown), such as for example external pneumatic valves or pneumatic cylinders. The main valves mostly are configured as gate valves. As a pilot valve, an electropneumatic valve usually is employed.

In general, compressed air is used here as control fluid, and the entire valve units 12a are designed for a pneumatic control. In principle, the valve island 10 might however also be designed for the use of a hydraulic fluid.

In the valve island 10 two intermediate feed modules 14 for feeding fluid into the valve island 10 via fluid ports 14a as well as an adapter module 16 also are provided here, which adapter module forms the left-hand end of the valve island 10.

The valve island 10 includes a fastening structure 18 that is provided on a first outer surface 20 and that extends in a line-up direction A, along which the individual modules 12, 14, 16 of the valve island 10 also are lined up.

In this example, the first outer surface 20 forms a rear side of the valve island 10, and the fastening structure 18 has the shape of a groove 22 that is configured such that the valve island 10 can be pushed onto a mounting rail 24, here in the form of a top-hat rail, or can be hooked in at the same in order to fasten the valve island 10 to the mounting rail 24. The mounting rail 24 mostly is fastened to the rear wall of a control cabinet, so that the entire valve island 10 can be mounted in the control cabinet by pushing on or hooking in at the mounting rail 24.

In this embodiment, the fastening structure 18 is arranged approximately centrally on the first outer surface 20 as seen along the vertical direction V (in the mounted condition) perpendicularly to the line-up direction A.

For contacting electrically, the valve island 10 includes a first contact area 26 and a second contact area 28 on a second surface 30 that extends substantially perpendicularly to the line-up direction A and here forms one of the front sides outwardly delimiting the valve island 10.

In this example, the electrical contact area 26 is provided exclusively for data lines. The same are combined here in a central data bus, wherein the electrical contact area 26 here is formed by a multipole plug. Via this central data bus any data can be transmitted and any suitable processes can be controlled.

The electrical contact area 28 on the other hand here exclusively serves the voltage supply. All voltage supply lines are combined here to a central supply bus. In this example, the electrical contact area 28 is configured as a socket. Here, the electrical contact area 28 also is of multipole design. Of course, it is left to the discretion of the skilled person to design the electrical contact areas 26, 28 each as a socket or as a plug.

The energy supply provided via the electrical contact area 28 here extends through the entire valve island 10, so that each of the modules 12, 14, 16 can access the central supply bus. The same applies for the central data bus that ends in the electrical contact area 26.

For this purpose, each of the individual modules 12, 14, 16 has corresponding electrical contact areas, so that when lining up the individual modules 12, 14, 16 in a line-up direction A, continuous data lines or continuous electric supply lines are formed. The individual electrical contact areas of the different modules 12, 14, 16 are of course designed complementarily, so that a contact area always meets a counter-contact area, which are configured to be plugged into each other.

The two electrical contact areas 26, 28 are configured and arranged such that the electrical contacting simply can be effected by plugging in a module in a line-up direction A.

Both the plug of the electrical contact area 26 and the socket of the electrical contact area 28 here are raised with respect to the second surface 30.

The two electrical contact areas 26, 28 are spatially separate from each other, wherein the fastening structure 18 lies between the two electrical contact areas 26, 28.

Advantageously, the fastening structure 18 lies between the two electrical contact areas 26, 28 as seen perpendicularly to the line-up direction A.

In this example, both electrical contact areas 26, 28 are arranged relatively close to the first outer surface 20. As seen in the vertical direction V perpendicular to the line-up direction A, the two electrical contact areas 26, 28 approximately lie on a straight line with the fastening structure 18.

In the region of the fastening structure 18 a latching device 36 is provided on the second surface 30, which here comprises a latching element 38 in the form of a latching hook which on plugging in a further module engages into a counter latching element formed thereon and thus secures the modules to each other.

For releasing the latching connection an actuating device 40 is provided, here on an underside 42 of the valve island 10, via which the latching element 38 is movable in order to release the latching connection.

It is possible to provide each of the modules 12, 14, 16 of the valve island 10 with such a latching device 36, or to provide the same only on individual modules 12, 14, 16.

In the exemplary embodiment shown here the second surface 30 also is an outwardly pointing first front side of the adapter module 16.

In this example, a circuit unit (not shown) is contained in the adapter module 16, which for example can provide a second, different supply voltage inside the valve island or also a further data bus inside the valve island. The circuit unit here is connected to the first and the second electrical contact area 26, 28 and hence both to the central supply bus and to the central data bus.

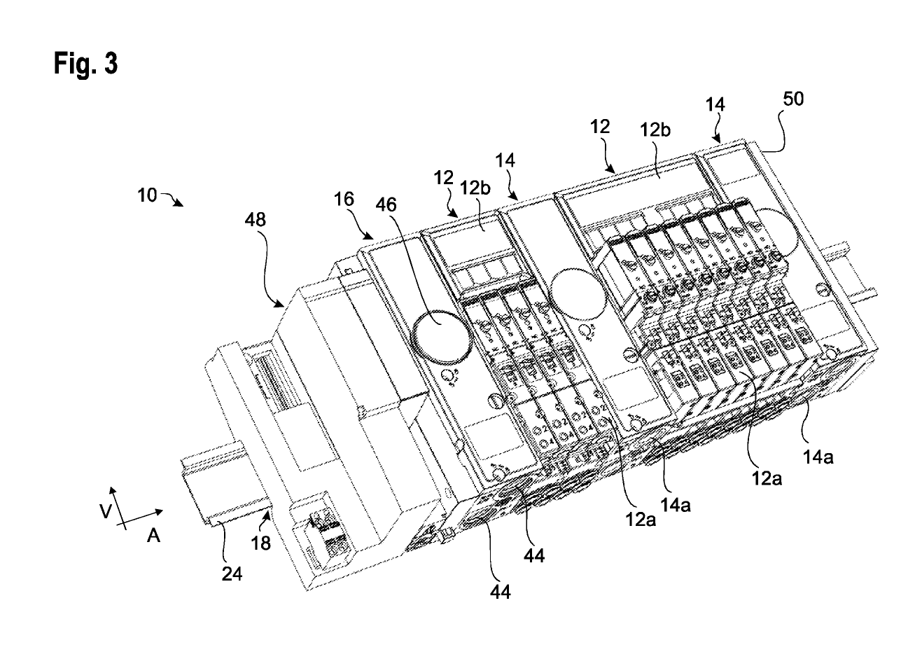

The adapter module 16 here is formed integrally with a feed module. However, these two components also might be separate. Due to the combination with the feed module, the adapter module 16 has at least one fluid port 44 through which fluid can be fed into the valve island 10 (see for example FIG. 3). On its front side directed towards the valve modules 12, the adapter module 16 therefore has one or more fluid ports via which the fluid fed in through the fluid ports 44 is passed on in the valve island 10.

The first front side of the adapter module 16, which forms the second surface 30, however is free from fluid ports.

The circuit unit of the adapter module 16 can comprise a pressure measuring device that can measure the fluid pressure within the adapter module 16. The measurement result and/or possibly a warning signal can be represented on a display device 46 of the adapter module 16. Alternatively or in addition, a signal can be output to the valve modules 12 on the data bus inside the valve island or on the central data bus. The circuit unit also can comprise a voltage testing device that monitors the voltage on the central supply bus and in the case of an overvoltage or undervoltage forwards control commands and/or warning signals to the remaining modules 12, 14 of the valve island 10 via the data bus inside the valve island or via the central data bus.

In this example, an electromagnetic protection device in the form of an EMC wiring also is provided in the adapter module 16, which is connected to the central voltage supply and the central data bus in order to reduce electromagnetic interferences.

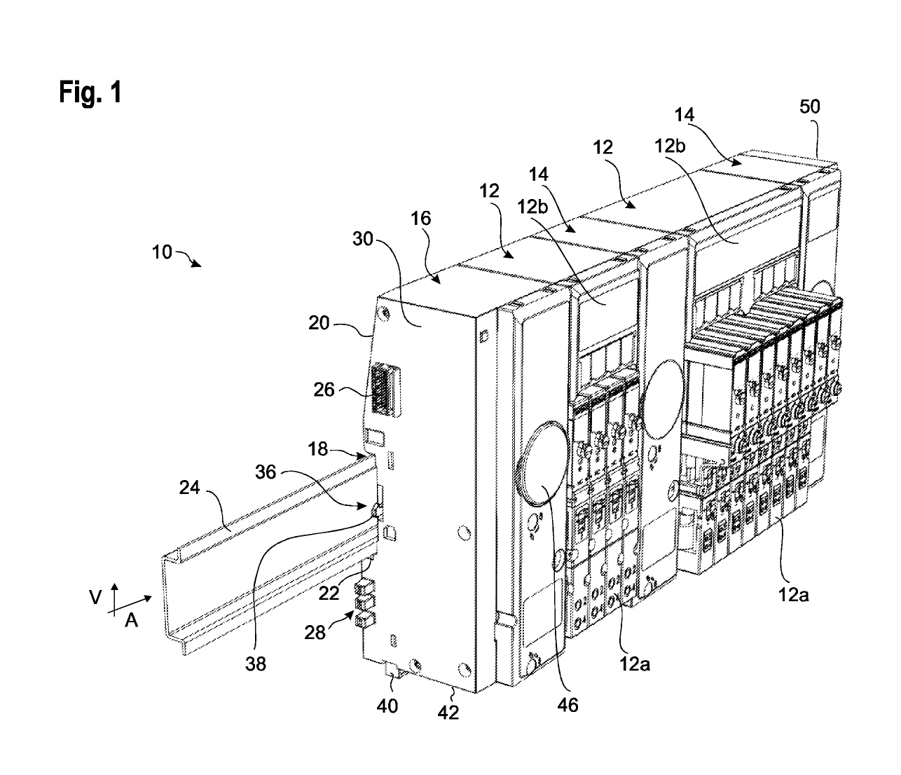

As can be seen in FIGS. 1 and 3, a further module 48 can be connected on the second surface 30, here on the free front side of the adapter module 16. This further module 48 normally is a purely electrical module, which for example includes controllers, bus interfaces and/or electrical inputs and outputs and can be e.g. a so-called I/O module. After plugging in the further module 48, the second surface 30 delimiting the adapter module 16 of course lies between the adapter module 16 and the further module 48.

Via correspondingly configured (non-illustrated) counter-contact areas on the further module 48 the same is electrically connected to the electrical contact areas 26, 28 of the adapter module 16. Due to the spatial separation of the two electrical contact areas 26, 28 the plug connection between the electrical contact areas 26, 28 and the corresponding counter-contact areas on the further module 48 can smoothly be closed and released again without a risk of canting by shifting the further module 48 along the line-up direction A.

The further module 48 here also includes a fastening structure 18 with which it can be pushed onto the mounting rail 24. As the two electrical contact areas 26, 28 are raised with respect to the second surface, a correct alignment and centering of the further module 48 with respect to the valve island 10 is automatically effected when pushing on the further module 48.

Possibly, the opposite front side 50 of the valve island 10 also can be provided with (mirror-symmetrical) electrical contact areas 26, 28 in order to provide for plugging in a second, further module 48 (not shown). In this case, the entire valve island 10 also can easily be mounted between further modules 48 on a mounting rail 24. On the front side 50 a latching device 36 or its counterpart preferably also is provided, in dependence on the formation of the further module 48 to be plugged in.

1. A valve island with at least one valve module, wherein the valve island has a fastening structure extending in a line-up direction (A) on a first outer surface and on at least one second surface that extends substantially perpendicular to the line-up direction (A) a first and a second electrical contact area, wherein the fastening structure lies between the two electrical contact areas.

2. The valve island according to claim 1, wherein the valve island includes a plurality of adjacent modules formed as separate assemblies, among them the at least one valve module, and that adjacent modules can be coupled to each other in a modular way and can again be constructionally separated from each other.

3. The valve island according to claim 1, wherein on the second surface at least one latching element of a latching device is provided.

4. The valve island according to claim 3, wherein the latching element is arranged in the region of the fastening structure.

5. The valve island according to claim 3, wherein the latching device comprises an actuating device, in particular on an underside of the valve island, by which the latching element can be moved.

6. The valve island according to claim 1, wherein one of the two electrical contact areas serves as a voltage supply of the valve island and the other electrical contact area serves as a data transmission.

7. The valve island according to claim 1, wherein one of the two electrical contact areas is configured as a plug and the other one is configured as a socket.

8. The valve island according to claim 1, wherein at least one of the electrical contact areas is raised with respect to the surrounding second surface.

9. The valve island according to claim 1, wherein the valve island comprises an adapter module on which the two electrical contact areas are provided, wherein a first front side of the adapter module forms at least one portion of the second surface of the valve island.

10. The valve island according to claim 9, wherein on the second surface at least one latching element of a latching device is provided and that the latching device is arranged on the adapter module.

11. The valve island according to claim 9, wherein a feed module is integrated into the adapter module, which is part of a fluid supply of the valve island.

12. The valve island according to claim 1, wherein the first front side of the adapter module is configured free from fluid ports.

13. The valve island according to claim 9, wherein the adapter module includes a circuit unit that is connected to the two electrical contact areas.

14. The valve island according to claim 9, wherein the two opposite end-face front sides of the valve island, which point in the line-up direction (A) and delimit the valve island, are formed by adapter modules.

15. The valve island according to claim 1, wherein a further module that includes at least one electrical counter-contact area and a fastening structure are provided, and wherein the at least one electrical counter-contact area of the further module makes a plug connection with one or both of the electrical contact areas.

16. The valve island according to claim 15, wherein the plug connection can be closed and released by shifting along the line-up direction (A).

17. The valve island according to claim 15, wherein the further module includes a counter latching element that makes a latching connection with an adjacent latching element.
